(19) United States
(12) Patent Application Publication
(10) Pub. No.: US 2002/0145578 A1
(43) Pub. Date: Oct. 10, 2002

(54) Liquid crystal display elements driving method and electronic apparatus

(75) Inventor: Akihiko Ito, Tatsuno-cho (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/090,784

(22) Filed: Mar. 6, 2002

(30) Foreign Application Priority Data
Mar. 19, 2001 (JP) 2001-078898

(51) Int. Cl. G09G 3/36

(52) U.S. Cl. 345/87

(57) ABSTRACT

A related art driving method in which four scanning electrodes are selected simultaneously, the power circuit is complex and the power consumption is large. A liquid crystal display elements driving method according to the invention includes the steps of: simultaneously applying scanning signals of one of three predetermined voltages to three scanning electrodes and thereby simultaneously selecting a prescribed number of liquid crystal display elements arranged for each of the three scanning electrodes, the one voltage being determined according to an orthogonal function that prescribes voltages to be applied to a plurality of scanning electrodes; and applying a data signal of one of the three voltages to each of the prescribed number of signal electrodes, the one voltage being determined according to display data that prescribe gray shades.

### BACKGROUND OF THE INVENTION

1. Field of Invention

The present invention relates to a method for driving liquid crystal display elements and an electronic apparatus utilizing the driving method.

2. Description of Related Art

A related art driving method (multi-line selection method; hereinafter referred to as “MLS”) of a liquid crystal display device is described in International Publication No. WO 93/18501. In this driving method, in a liquid crystal display panel in which matrix-arranged pixels are formed by scanning electrodes and signal electrodes that cross each other, sets of scanning electrodes are selected sequentially (a plurality of scanning electrodes are selected simultaneously).

FIG. 5 shows a driving method in which scanning electrodes of four lines (i.e., four scanning electrodes) are selected simultaneously each time. In FIG. 5, symbols Y1-Y8 denote scanning potential waveforms that are applied to scanning electrodes and symbol X1 denotes a signal potential waveform that is applied to a signal electrode. A selection potential V3 or −V3 is applied to a scanning electrode in a selection period (H) of each of four fields 1f-4f that constitute one frame (F).

FIG. 3 shows a relationship between the voltage applied to a liquid crystal and the luminance. Liquid crystal-1 has an advantage that the drive voltage is low but also has a disadvantage that (saturation voltage)/(threshold voltage)=(Vs1/Vt1) is large. On the other hand, liquid crystal-2 has an advantage that (saturation voltage)/(threshold voltage)=Vs2/Vt2 is small but also has a disadvantage that the drive voltage needs to be high. Where MLS is employed and the number of scanning electrodes is large, a liquid crystal having a characteristic like the characteristic of liquid crystal-2 is used frequently though the drive voltage needs to be high. On the other hand, where the number of scanning electrodes is small (about 32 or less), a liquid crystal having a characteristic like the characteristic of liquid crystal-1 is used frequently.

### SUMMARY OF THE INVENTION

A case exists where a liquid crystal having a characteristic like the characteristic of liquid crystal-1 is used and driven by such voltages that the ratio between on and off effective voltages applied to the liquid crystal is maximized in the related art driving method shown in FIG. 5 in which four scanning electrodes are selected simultaneously. In this case, to drive, for example, a liquid crystal panel having 32 scanning electrodes (lines) and a liquid crystal-1-type liquid crystal having a threshold voltage Vt1 of 1.2 V, V3 and V2 are set at about 2.7 V and about 1.9 V, respectively. To drive a liquid crystal panel having 64 scanning electrodes (lines), V3 and V2 are set at about 3.6 V and about 1.8 V, respectively. Therefore, seven drive voltage levels are necessary, selection potentials that are output from a scanning-electrode-side driving circuit are high, and the differences between selection potentials that are output from the scanning-electrode-side driving circuit and signal potentials that are output from a signal-electrode-side driving circuit are large. As a result, with the related art driving method in which four scanning electrodes are selected simultaneously, a complex power circuit is needed and the power consumption is large. It is difficult to incorporate a scanning electrode driver and a signal electrode driver in a single integrated circuit (hereinafter “IC”).

Therefore, an object of the invention is to provide a method for driving liquid crystal display elements capable of reducing the number of drive voltage levels and the power consumption as well as an electronic apparatus that utilizes the driving method.

To address the above object, a liquid crystal display elements driving method according to the invention is provided for causing liquid crystal display elements to display gradations that they should display by using a plurality of scanning electrodes for each of which a prescribed number of liquid crystal display elements are arranged and a prescribed number of signal electrodes that cross the plurality of scanning electrodes and correspond to the prescribed number of liquid crystal display elements, respectively. The method includes steps of simultaneously applying scanning signals of one of three predetermined voltages to three scanning electrodes and thereby simultaneously selecting the prescribed number of liquid crystal display elements arranged for each of the three scanning electrodes, the one voltage being determined according to an orthogonal function that prescribes voltages to be applied to the plurality of scanning electrodes; and applying a data signal of one of the three voltages to each of the prescribed number of signal electrodes, the one voltage being determined according to display data that prescribe gradations. It is desirable that maximum and minimum voltages of the three voltages have the same amplitude and opposite polarities.

An electronic apparatus according to the invention utilizes the above liquid crystal display elements driving method.

According to another aspect of the present invention, there is provided a liquid crystal display device in which a plurality of scanning electrodes and a plurality of signal electrodes are arranged so as to cross each other, the scanning electrodes are divided into groups each consisting of n (n≧2) scanning electrodes that are selected simultaneously, and selection among the scanning electrodes is performed group by group, wherein selection signals that are orthogonal to each other in a certain period are applied simultaneously to the scanning electrodes belonging to the same group, the number of drive potential levels is three, and a maximum voltage amplitude given to the scanning electrodes is set equal to a maximum voltage amplitude given to the signal electrodes.

According to further another aspect of the present invention, there is provided a driving method of a liquid crystal display device in which a plurality of scanning electrodes and a plurality of signal electrodes are arranged so as to cross each other, the scanning electrodes are divided into groups each consisting of n (n≧2) scanning electrodes that are selected simultaneously, and selection among the scanning electrodes is performed group by group, wherein

selection signals that are orthogonal to each other in a certain period are applied simultaneously to the scanning electrodes belonging to the same group, the number of drive potential levels is three, and a maximum voltage amplitude given to the scanning electrodes is set equal to a maximum voltage amplitude given to the signal electrodes.

According to still another aspect of the present invention, there is provided a driving method of a liquid crystal display device in which a plurality of scanning electrodes and a plurality of signal electrodes are arranged so as to cross each other, the scanning electrodes are divided into groups each consisting of n (n≧2) scanning electrodes that are selected simultaneously, and selection among the scanning electrodes is performed group by group, wherein a first potential or a second potential that is opposite in polarity to and has the same absolute value as the first potential with respect to an average of potentials applied to the respective scanning electrodes is selectively applied to the signal electrodes; and the first or second potential is selectively applied to a scanning electrode corresponding to a display position in a period when the first or second potential is applied to the signal electrodes.

According to still another aspect of the present invention, there is provided a driving circuit of a liquid crystal display device which drives a liquid crystal display device in which a plurality of scanning electrodes and a plurality of signal electrodes are arranged so as to cross each other, the scanning electrodes are divided into groups each consisting of n (n≧2) scanning electrodes that are selected simultaneously, and selection among the scanning electrodes is performed group by group, wherein

selection signals that are orthogonal to each other in a certain period are applied simultaneously to the scanning electrodes belonging to the same group, the number of drive potential levels is three, and a maximum voltage amplitude given to the scanning electrodes is set equal to a maximum voltage amplitude given to the signal electrodes.

According to still another aspect of the present invention, there is provided a driving circuit of a liquid crystal display device which drives a liquid crystal display device in which a plurality of scanning electrodes and a plurality of signal electrodes are arranged so as to cross each other, the scanning electrodes are divided into groups each consisting of n (n≧2) scanning electrodes that are selected simultaneously, and selection among the scanning electrodes is performed group by group, wherein

a first potential or a second potential that is opposite in polarity to and has the same absolute value as the first potential with respect to an average of potentials applied to the respective scanning electrodes is selectively applied to the signal electrodes; and

the first or second potential is selectively applied to a scanning electrode corresponding to a display position in a period when the first or second potential is applied to the signal electrodes.

### BRIEF DESCRIPTION OF THE DRAWINGS

FIG. 1 is a drive waveform diagram showing an exemplary driving method according to a first embodiment of the present invention;

FIG. 2 is a drive waveform diagram showing an exemplary driving method according to a second embodiment of the invention;

FIG. 3 is a graph showing an example optical characteristic, that is, a relationship between the effective voltage applied to a liquid crystal and the luminance;

FIG. 4 is a schematic of an exemplary liquid crystal display device;

FIG. 5 is a drive waveform diagram showing a related art driving method of a liquid crystal display device;

FIG. 6 is a schematic of a scanning-electrode-side driving circuit (Y driver) of the liquid crystal display device according to the first embodiment;

FIG. 7 is a connection diagram of a plurality of scanning-electrode-side driving circuits (Y drivers) that are connected to each other in cascade;

FIG. 8 is a schematic of a potential selector 222 in the scanning-electrode-side driving circuit according to the first embodiment;

FIG. 9 is a schematic of a signal-electrode-side driving circuit (X driver) according to the first embodiment;

FIG. 10 is a circuit diagram of a non-coincidence number judgment circuit in the signal-electrode-side driving circuit (X driver) according to the first embodiment;

FIG. 11 is a schematic of a potential selector 260 in the signal-electrode-side driving circuit (X driver) according to the first embodiment;

FIGS. 12(a) and 12(b) are truth tables for the potential selector 260;

FIG. 13 is a circuit diagram showing a charge pump action of a power circuit according to the first embodiment;

FIG. 14 is a schematic of the power circuit used in the first embodiment;

FIGS. 15(a)-15(c) are schematics of various modifications of the power circuit;

FIGS. 16(a)-16(c) show various electronic apparatuses according to a fourth embodiment of the invention;

FIG. 17 is a plan view of a first substrate of an electro-optical device according to a third embodiment of the invention; and

FIG. 18 is a plan view of a second substrate of the electro-optical device according to the third embodiment.

### DETAILED DESCRIPTION OF PREFERRED EMBODIMENTS

1. Embodiment 1

1.1 Entire Configuration of Embodiment

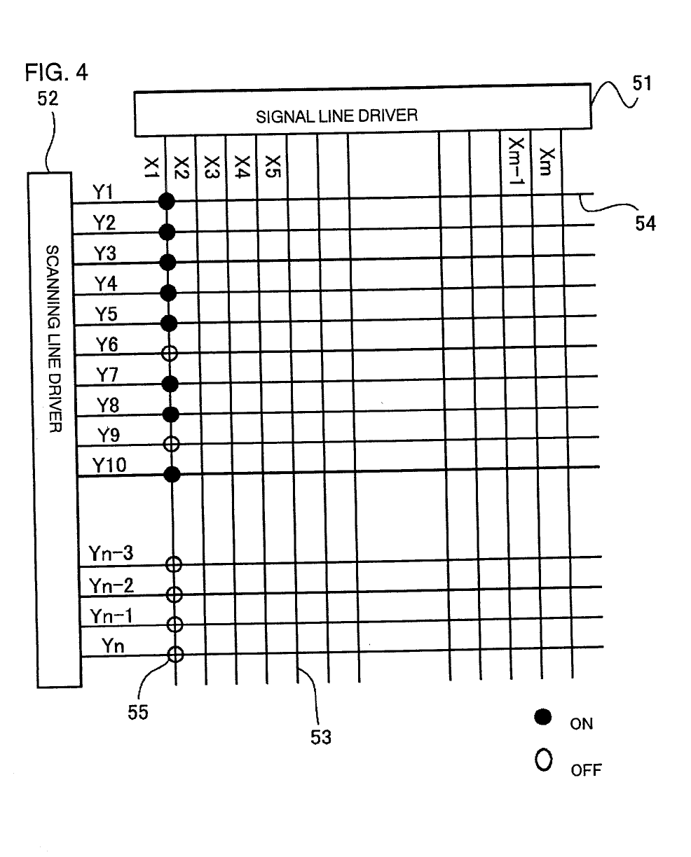

FIG. 4 is a schematic of a liquid crystal display device as an exemplary electro-optical device according to this embodiment. The liquid crystal display device according to this embodiment is provided such that a first substrate having scanning electrodes 54 (Y1-Yn) formed on an inner surface thereof and a second substrate having signal electrodes 53 (X1-Xm) formed on an inner surface thereof are opposed to each other, and that an STN (super twisted nematic) liquid crystal in which liquid crystal molecules are arranged with a twist of 180° or more is interposed between the above paired substrates. In this liquid crystal display device, polarizing plates are disposed outside the respective paired substrates, and a phase plate is disposed between at least one of the polarizing plates and the associated substrate. This embodiment will be described for an exemplary liquid crystal display device that is a reflection-type liquid crystal display device in which a reflection plate is disposed outside of the one polarizing plate located on the opposite side to a viewer's side, and black display is effected when a voltage is applied to the liquid crystal.

A scanning line driver (also called “scanning-electrode-side driving circuit” or “Y driver”) 52 shown in FIG. 4 applies scanning potential waveforms (described later) to the scanning electrodes 54. A signal line driver (also called “signal-electrode-side driving circuit” or “X driver”) 51 shown in FIG. 4 applies signal potential waveforms (described below) to the signal electrodes 53. Pixels are arranged in matrix form at the crossing points of the scanning electrodes 54 and the signal electrodes 53. An effective voltage, that is a difference voltage between a scanning potential waveform and a signal potential waveform, is applied to a liquid crystal portion at a pixel position. On-display (black display) is effected if the effective voltage is higher than the saturation value of the liquid crystal. Off-display (white display; or color display corresponding to the pixel if the liquid crystal panel is a color display device) is effected if the effective voltage is lower than the threshold value. Intermediate display between the on-display and off-display is effected if the effective voltage is between the threshold value and the saturation value. Alternatively, a liquid crystal display device may be formed as a transmission-type display device, in which case off-display is effected by the application of an effective voltage that is higher than the saturation voltage of the liquid crystal and on-display is effected is effected by the application of an effective voltage that is lower than the threshold voltage.

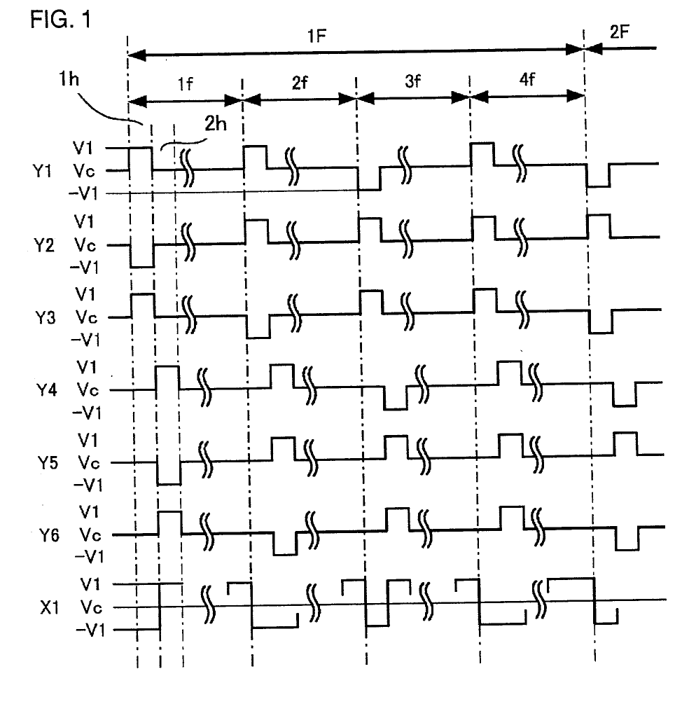

FIG. 1 shows drive waveforms of the liquid crystal display device of FIG. 4. The driving method shown in FIG. 1 is a driving method (multi-line selection method) in which sets of three scanning electrodes (lines) are selected sequentially (three scanning electrodes are selected simultaneously). That is, first to third scanning electrodes (numbered from the top) constitute a first group and fourth to sixth scanning electrodes constitute a second group. This applies to the remaining scanning electrodes that are not shown in FIG. 1.

One frame is divided into four fields (1f-4f). In the first to third fields (1f-3f), selection potentials, having signal polarities that are orthogonal to each other in a certain period, are applied simultaneously according to an orthonormal matrix to selected scanning electrodes of each group. (For example, the signal potential of a selection potential applied to one of three simultaneously selected lines is opposite to that of selection potentials applied to the other lines. Each line is selected three times during one frame period in such a manner as to be supplied once with a selection potential having a signal polarity that is opposite to the signal polarity of selection potentials applied to the other lines.) In contrast, in the fourth field (4f), selection potentials applied to the respective scanning electrodes have the same polarity. AC driving is performed by applying selection potentials having different polarities to each scanning electrode in first and second frames. The polarity switching need not always be made every frame, and instead it may be made at a certain cycle.

In this driving method, 3-line selection periods (h) are distributed so as to occur periodically in each frame (1F), and each line is selected once in each of the four fields (1f-4f) of each frame. Symbols Y1-Y6 denote scanning potential waveforms that are applied to the respective scanning electrodes Y1-Y6 shown in FIG. 4, which is the schematic of the liquid crystal display device. Symbol X1 denotes a signal potential waveform that is applied to the signal electrode X1 when a display shown on the signal electrode X1 in FIG. 4 is intended.

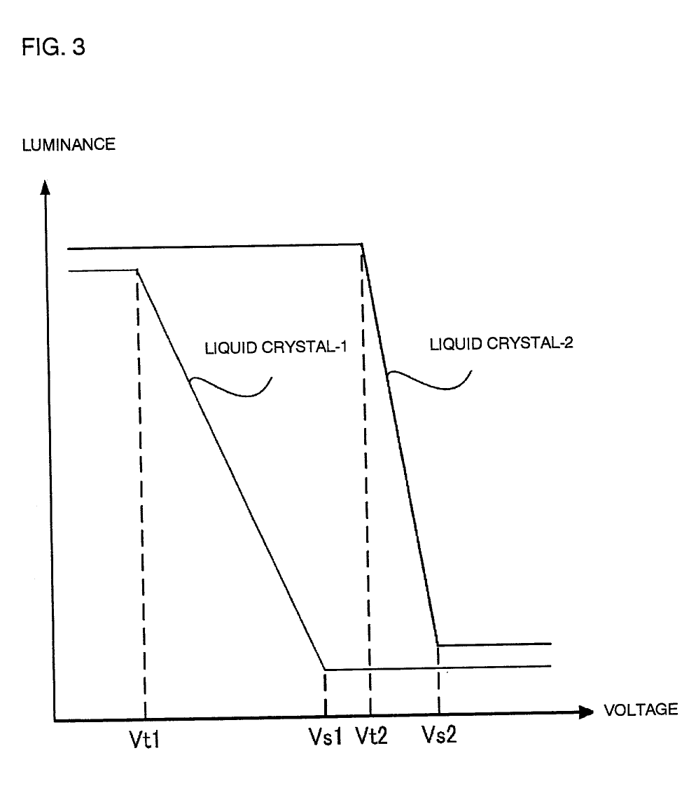

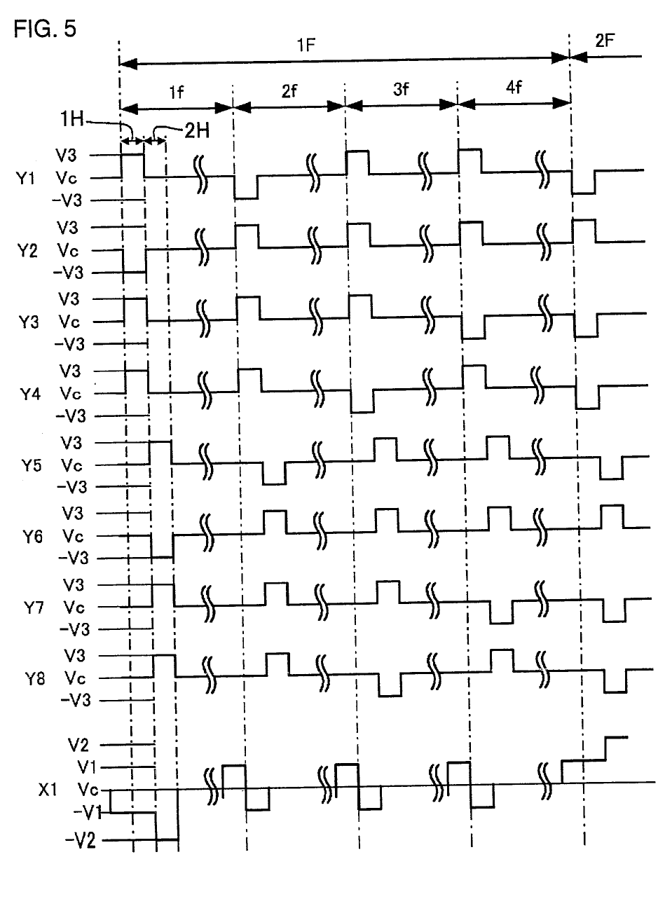

One feature of this embodiment is that scanning potential waveforms (selection potentials) and signal potential waveforms are given the same amplitude, as shown in FIG. 1. Specifically, with a reference voltage Vc (e.g., 0 V), a positive-side selection potential V1 of scanning potential waveforms and a positive-side potential V1 of signal potential waveforms are given the same voltage level, and a negative-side selection potential −V1 of scanning potential waveforms and a negative-side potential −V1 of signal potential waveforms are given the same voltage level. Thus, the number of drive voltage levels can be decreased from seven (see FIG. 5) to three. The characteristics of liquid crystals used were described above with reference to FIG. 3. In this embodiment, a liquid-crystal-2-type liquid crystal is used in this embodiment.

With the above liquid crystal, the drive voltage can be a little high, but sufficient contrast can be secured even if the difference between on/off effective voltages is small. This will be described below in more detail. A description will be provided of a case where the number of scanning electrodes is equal to 33. Where the above driving method is employed, if the threshold voltage of the liquid crystal is equal to 1.41 V, the voltage V1 that is applied to the liquid crystal is set to about 1.4 V with respect to Vc=0 V. In this case, the on-voltage/off-voltage ratio of the effective voltage applied to the liquid crystal is equal to about 1.086. In the case of FIG. 3, Vs1/Vt1 is equal to about 1.07. Sufficient contrast can be secured because 1.07<1.086. In other words, according to this embodiment, 2.8 V is enough as the absolute value of the voltages +V1. This makes it possible to drive an electro-optical device without the necessity of using any booster circuit because typical small-size electronic equipment employs a power supply voltage of 3 V in many cases.

1.2 Configuration of Scanning-electrode-side Driving Circuit

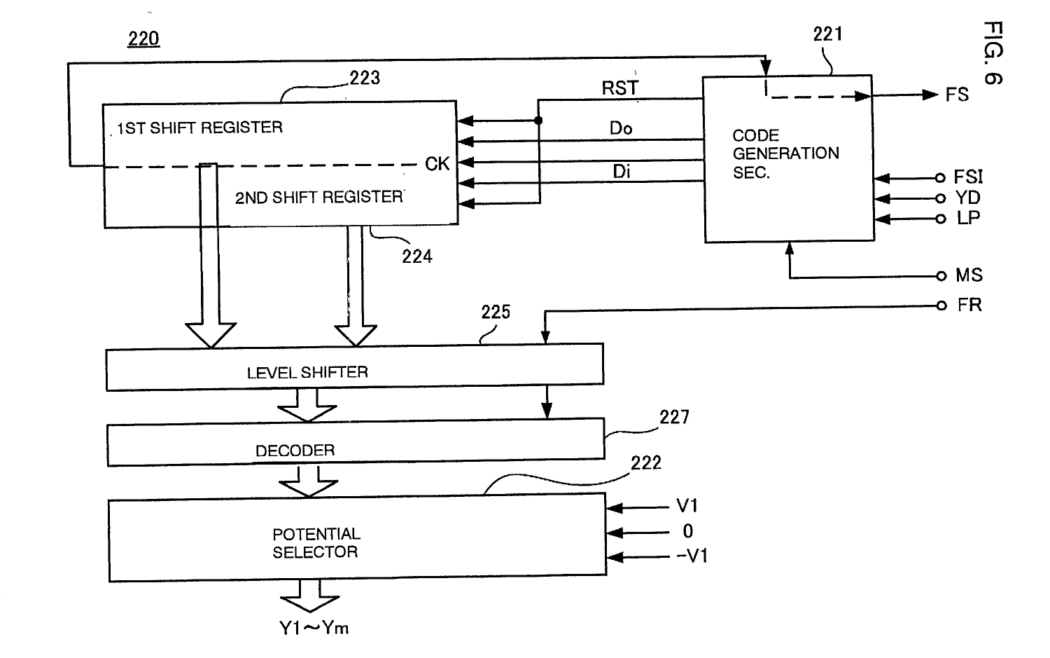

Next, a scanning-electrode-side driving circuit (Y driver) 220 according to this embodiment that corresponds to the scanning line driver 52 in FIG. 4 will be described with reference to FIG. 6. This embodiment will be described for a case where the number of scanning electrodes is equal to 33. The scanning-electrode-side driving circuit 220 is a semiconductor integrated circuit having a code generation section 221 and other various circuits that are described below. As shown in FIG. 6, the code generation section 221 generates potential selection sequence patterns for the scanning electrodes field by field based on frame start pulses YD and latch pulses LP and signals coming from a control circuit (not shown) that receives display data and control signals from an MPU or the like and generates timing signals and display data necessary to drive the liquid crystal display device.

In this embodiment, the potentials applied to the scanning electrodes Y1-Yn have three potential levels in total, that is, V1 or −V1 (selection periods) and 0 V (non-selection periods). Therefore, selection control information that is supplied to a potential selector 222 must be of two bits for each of the scanning electrodes Y1-Yn. To this end, the code generation section 221 for simultaneous selection of a plurality of lines initializes a field counter (not shown) and first and second shift registers 223 and 224 by a frame start pulse YD, and then transfers, to a first shift register 223 and a second shift register 224 for serial-to-parallel conversion, 2-bit potential selection codes D0 and D1 indicating a sequence pattern of selection potentials to be applied to each scanning electrode in a first field. Each of the first shift register 223 and the second shift register 224 is a shift register of 33 bits that corresponds to the number of scanning electrodes. The first shift register 223 and the second shift register 224 store the lower-bit potential selection code D0 and the higher-bit potential selection code D1, respectively, in response to the same shift clock CK. The shift clocks CK are generated by a timing generation circuit (not shown) of the code generation section 221. As for the shift register, a single, 66-bit shift register is not provided for the shift clocks CK. Instead, the 33-bit first and second shift registers 223 and 224 are provided parallel for the shift clocks CK. Therefore, the shift register can operate at a low frequency in response to the latch pulses LP and hence can operate with very low power consumption.

The potential selection codes D0 and D1 of the respective bits in the first shift register 223 and the second shift register 224 are shifted to the adjacent bits in response to generation of a shift clock CK and output-maintained for a selection time Δt. Outputs of the shift register is supplied to a level shifter 225, where they are converted from a low logic amplitude level to a high logic amplitude level. No level shifter is needed in the case where the drive voltage of the liquid crystal is lower than the logic voltage of the shifter register, etc. The potential selection codes D0 and D1 of the high logic amplitude level that are output from the level shifter 225 are supplied, together with a liquid crystal alternating signal FR that has been level-converted simultaneously, to a decoder 227 as a waveform shaping section, which generates a selection control signal. A potential selector 222 is switching-controlled by the selection control signal, whereby one of the potentials V1, Vc (0 V), and −V1 shown in FIG. 1 is applied to each of the scanning electrodes Y1-Yn.

FIG. 8 is a schematic of the potential selector 222. The potential selector 222 is formed of an analog switch 222A that receives, at an input terminal, a potential V1 from a power circuit (described later), an analog switch 222B that receives, at an input terminal, a potential Vc, and an analog switch 222C that receives, at an input terminal, a potential −V1. Selection control signals Q2, Q1, and Q0 are input to the respective analog switches 222A-222C.

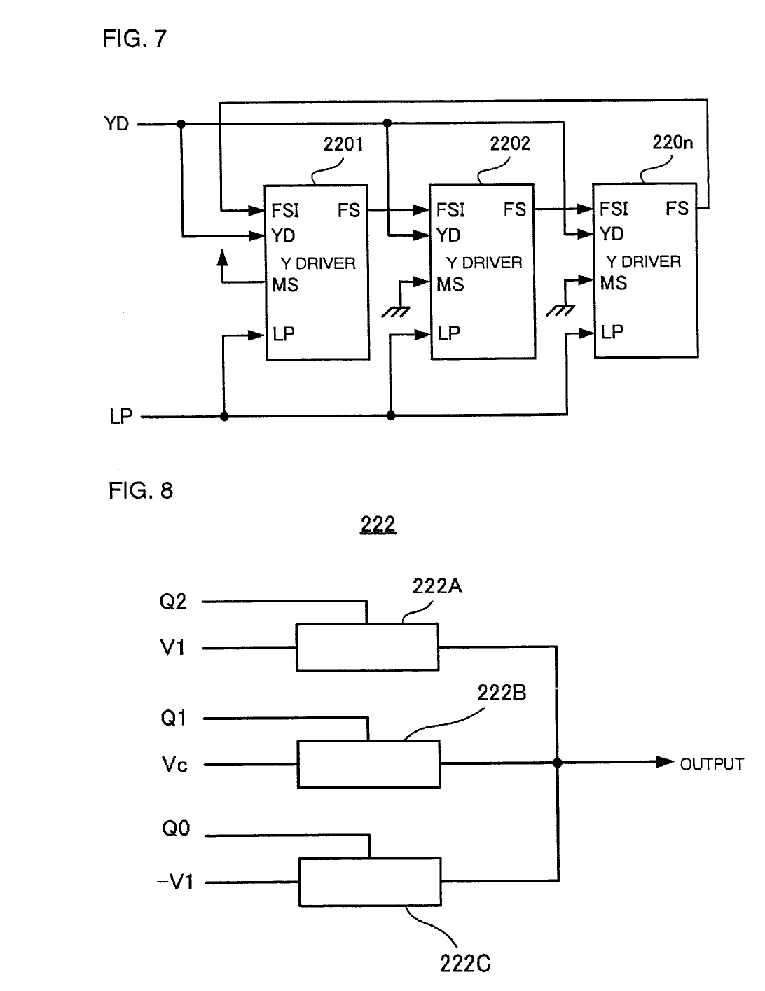

In this embodiment, it is assumed that, to enable cascade connection of a plurality of scanning-electrode-side driving circuits (Y drivers 1-n), the function of the code generation section 221 can be changed between the function of a first-stage Y driver 2201, and that of a second and following Y drivers 2202-220n by using select terminals MS, as shown in FIG. 7. Specifically, the first-stage Y driver 2201 performs initialization (described above) by a frame start pulse YD, and then makes a transition to an operation (described above) of generating potential selection codes and supplying to the two shift registers 223 and 224. In contrast, each of the second and following Y drivers 2202-220n does not automatically make a transition to an operation of generating potential selection codes because of a low-level input to the select terminal MS. Each of the second and following Y drivers 2202-220n generates potential selection codes and supplies to the two shift registers 223 and 224 only after receiving a carry signal (FS) of the first stage at an FSI input terminal. The first field ends when the final-stage Y driver n outputs a carry signal (FS). At this time point, no second field start signal arrives from a controller. Therefore, the carry signal (FS) of the final-stage Y driver n is fed back to the FSI terminal of the first-stage Y driver 2201 and an FS terminal of the X driver, and generates potential selection codes of the second field and supplies those codes to the two shift registers 223 and 224. Then, the same operation as in the first field is performed in the second, third, and fourth fields. Then, a transition is made to the next field (first field). The above function relaxes the restrictions on the number of lines selected simultaneously and the number of terminals of the Y driver that are imposed on the controller, and enables use of frame start pulses YD and latch pulses LP having the same frequencies as used in the related art voltage averaging method.

1.3 Configuration of Signal-electrode-side Driving Circuit

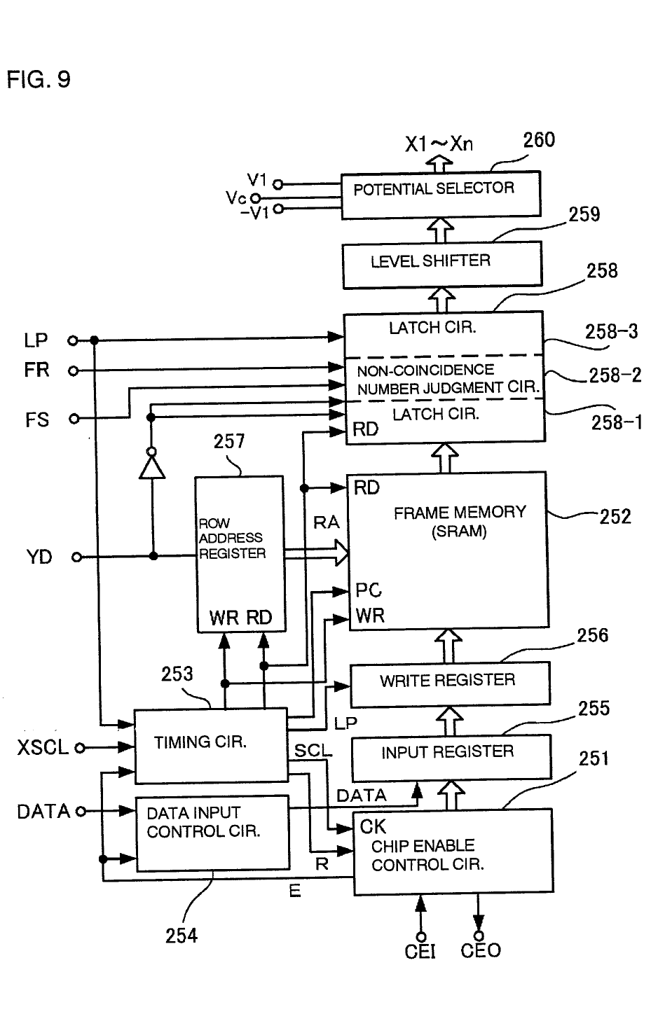

Next, the configuration of the signal-electrode-side driving circuit (X driver) will be described. The X driver is a semiconductor integrated circuit having a configuration shown in FIG. 9. A plurality of X drivers can be connected to each other in cascade fashion via chip enable outputs CEO and chip enable inputs CEI. In FIG. 9, reference numeral 251 denotes a chip enable control circuit and functions as an active-low automatic power saving circuit. Reference numeral 253 denotes a liming circuit that generates necessary timing signals etc. based on signals that are supplied from a control circuit (not shown). Reference numeral 255 denotes an input register that sequentially (every time a shift clock XSCL falls) captures display data DATA (1 bit, 4 bits, or 8 bits) that are transferred from the control circuit in response to the generation of an enable signal E, and stores display data DATA of one scanning line.

Reference numeral 256 denotes a write register that latches together display data DATA of one scanning line supplied from the input register 255 at a fall of a latch pulse LP, and writes those to a memory matrix of a frame memory (SRAM) 252 in a write time that is longer than one shift clock XSCL. Reference numeral 257 denotes a row address register that is initialized by a scan start signal YD and sequentially (every time a write control signal WR or a read control signal RD is applied) selects rows (word lines) of the frame memory 252. Reference numeral 258 denotes a signal potential determination circuit that determines, based on a set of display data supplied from the frame memory 252 and a potential selection pattern for a scanning electrode, information of potentials to be applied to the corresponding signal electrode.

Reference numeral 259 denotes a level shifter that converts signals of a low logic amplitude level that are supplied from the signal potential determination circuit 258 into signals of a high logic amplitude level. (The level shifter 259 is not necessary in the case where the drive voltage of the liquid crystal is lower than the logic voltage of the signal potential determination circuit 258, etc.) Reference numeral 260 denotes a potential selector that selects one of three potential levels V1, Vc (0 V), and −V1 according to each potential selection code signal of the high logic amplitude level that is output from the level shifter 259 and applies the selected potentials to the respective signal electrodes X1-Xn. Usually, the level of signal potential waveforms is V1 or −V1, as shown in FIG. 1. However, for example, when it is intended to display information only in a partial display area, applying Vc (0 V) in the area that is not used for display is advantageous to reduce power consumption. For this reason, Vc (0 V) is made selectable in the potential selector 260.

The signal potential determination circuit 258 is provided with a latch circuit 258-1, a non-coincidence number judgment circuit 258-2, and a latch circuit 258-3. The latch circuit 258-1 latches display data that are output from the frame memory 252, and outputs display data a1, a2, and a3 for each group of three pixels arranged in the Y direction, that is, for three respective lines (arranged downward) to be selected simultaneously. The display data a1, a2, and a3 are “1” if the pixel should be turned on, and are “0” if the pixel should be turned off.

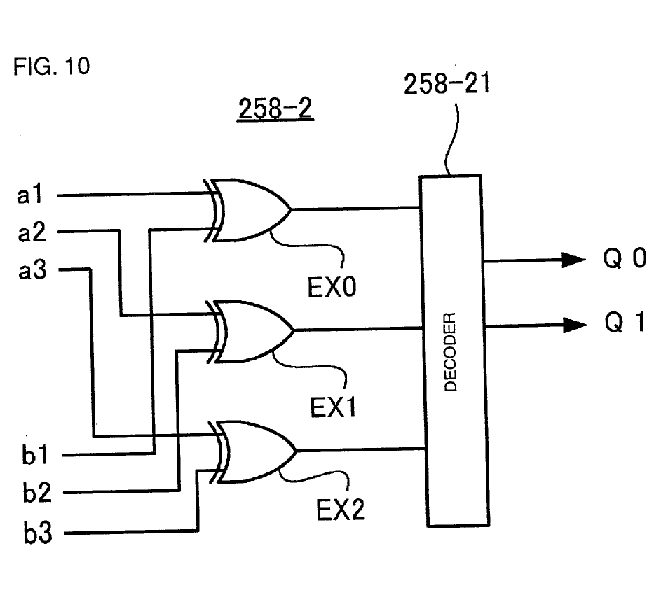

Next, the details of the non-coincidence number judgment circuit 258-2 will be described with reference to FIG. 10. In FIG. 10, b1, b2, and b3 are signals representing potential selection patterns (see FIG. 1) for three respective scanning electrodes (arranged downward) to be selected simultaneously, and have a value “1” if the potential is equal to V1 and have a value “0” if the potential is equal to −V1. Reference symbols EX0, EX1, and EX2 are exclusive-OR gates that output EXCLUSIVE-ORed results of a1 and b1, a2 and b2, and a3 and b3, respectively. In other words, the exclusive-OR gates EX0, EX1, and EX2 compares, bit by bit, the display data a1, a2, and a3 with the potential selection patterns b1, b2, and b3 for the scanning electrodes, respectively, and output “1” for a non-coincidence bit and “0” for a coincidence bit. Reference numeral 258-21 denotes a decoder. The decoder 258-21 causes a selection control signal Q0 to rise to command output of a potential −V1 if the number of non-coincidence bits is equal to 0 or 1, and causes a selection control signal Q1 to rise to command output of a potential V1 if the number of non-coincidence bits is equal to 2 or 3.

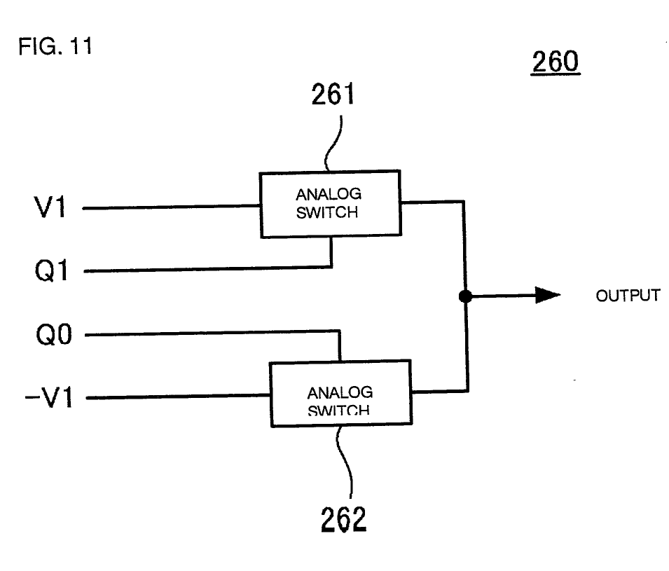

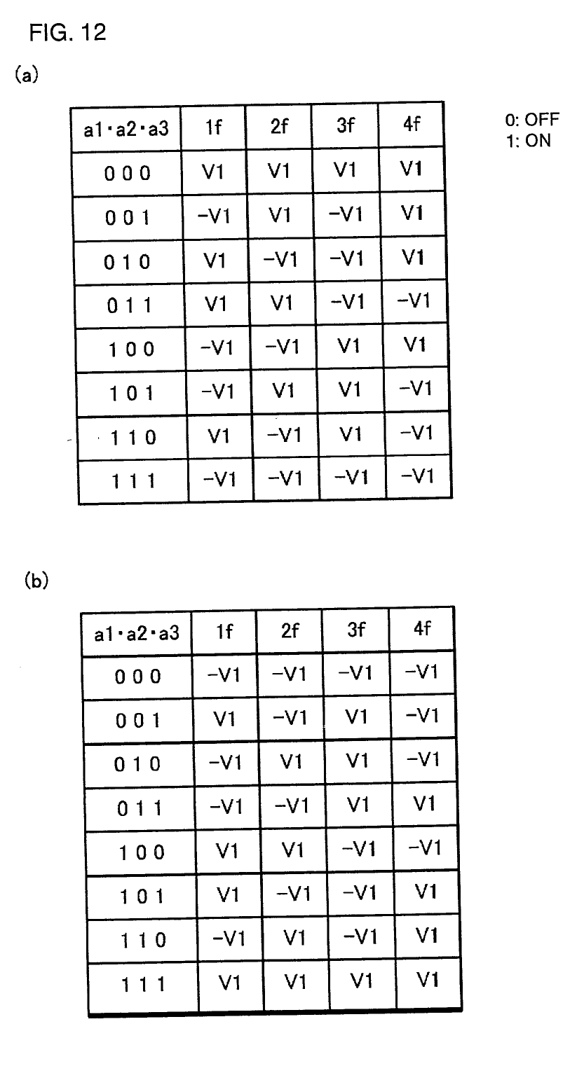

FIG. 11 is a schematic showing the potential selector 260. The selection control signals Q0 and Q1 generated by the non-coincidence number judgment circuit 258-2 are input to the potential selector 260 via the latch circuit 258-3 and the level shifter 259. The potential selector 260 is provided with analog switches 261 and 262. Potentials V1 and −V1 are supplied to the input terminals of the respective analog switches 261 and 262. The selection control signals Q1 and Q0 are input to the control terminals of the respective analog switches 261 and 262. The analog switches 261 and 262 select one of the two potential levels. FIG. 12(a) is a truth table showing potentials that are actually selected in the individual fields according to the values of the display data a1, a2, and a3 in the IF period (see FIG. 1). FIG. 12(b) is a truth table showing potentials that are actually selected in the individual fields in the case where selection potentials that are applied to the scanning electrodes have polarities opposite to the polarities in the IF period.

The above potential selection operation will be described below in more detail. First, referring to FIG. 4, since all the pixels on the first column that correspond to the scanning electrodes Y1-Y3 should be turned on, the corresponding display data a1, a2, and a3 become “1,” “1,” and “1.” Similarly, the display data a1, a2, and a3 for the pixels on the first column that correspond to the scanning electrodes Y4-Y6 become “1,” “1,” and “0.” Referring to FIG. 1, since potentials to be applied to the scanning electrodes (arranged downward) of each group in the first field (f1) are V1, −V1, and V1, respectively, the potential selection patterns b1, b2, and b3 are equal to “1,” “0,” and “1.” Therefore, when they are compared with the display data (a1, a2, a3)=(1, 1, 1), it is found that the non-coincidence number is equal to “1.” Therefore, the level of the signal potential waveform X1 is set to −V1 in the first group selection period (1h) of the first field (1f) in FIG. 1.

Then, in the second group selection period (2h), the display data (a1, a2, a3) (1, 1, 0) are compared with the potential selection patterns (b1, b2, b3)=(1, 0, 1) and it is found that the non-coincidence number is equal to “2.” Therefore, the level of the signal potential waveform X1 is set to V1 in the second group selection period (2h) of the first field (1f). The level of the signal potential waveform X1 is determined similarly in the other fields and the other group selection periods. After the completion of the display in the first frame (1F), similar operations are repeated in the second (2F) and following frames, while the polarities of scanning potentials and signal potentials are inverted frame by frame.

1.4 Configuration of Power Circuit

Next, the power circuit for supplying the 3-level potentials to the signal-electrode-side driving circuit and the scanning-electrode-side driving circuit will be described with reference to FIG. 14.

This power circuit has input supply voltages of only Vcc (first input potential) and GND (second input potential) and hence is of a single voltage input type. The power circuit receives latch pulses LP that are pulses generated in respective horizontal scanning periods. A clock forming circuit 21 forms a clock signal that is necessary for a charge pump circuit based on the latch pulses LP. Of the supply voltages Vcc and GND, the clock forming circuit 21 employs GND as −V1. And the clock forming circuit 21 determines the other potential levels using GND as a reference. Although the description with reference to FIG. 1 was made with the assumption of Vc=0 V, this power circuit generates drive potentials that are on the positive side of GND. The same effective voltage is applied to the liquid crystal whichever potential relationship is employed to drive the liquid crystal display device. However, the configuration of the power circuit is simplified in the case of generating drive potentials, all of which are on the positive side.

In FIG. 14, reference numeral 23 denotes a regulator that converts the potential Vcc (e.g., 3 V) into a potential 2·V1 (e.g., 2.8 V) that is lower than Vcc (reference: GND), and outputs the resulting voltage as the potential V1 shown in FIG. 1. Reference numeral 22 is a ½ voltage reduction circuit that converts the voltage between the output terminal of the regulator 23 and GND into ½, and outputs the resulting voltage as the potential Vc shown in FIG. 1. The ½ voltage reduction circuit generates the potential Vc by a charge pump action.

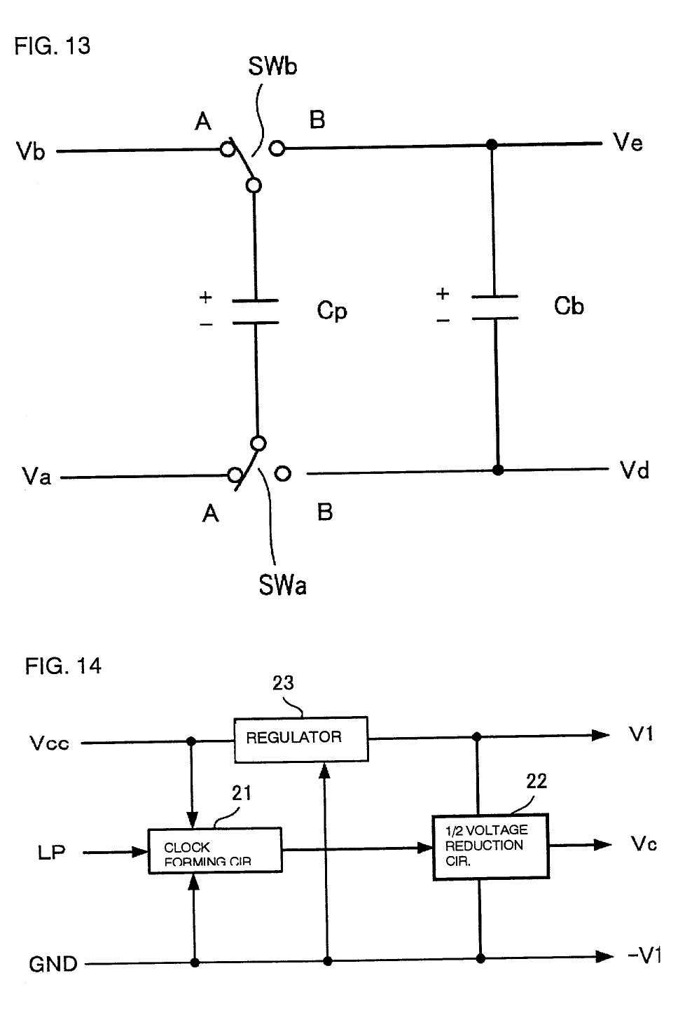

FIG. 13 is a conceptual diagram showing the basic principle of the charge pump circuit. In FIG. 13, reference symbols SWa and SWb are linked switches that are operate in such a manner that, while one of the switches SWa and SWb is switched to terminal A, for example, the other is also switched to terminal A. Although in FIG. 13 the switches SWa and SWb are drawn as mechanical switches, actually each of the switches SWa and SWb can usually be formed by two transistor switches, that is, a MOS transistor that controls the connection to and the disconnection from terminal A, and a MOS transistor that controls the connection to and the disconnection from terminal B.

While the switches SWa and SWb are switched to terminals A, a pumping capacitor Cp is charged by a voltage Vb-Va. Then, when switching is made to terminals B in the switches SWa and SWb, the accumulated charge in the pumping capacitor Cp is transferred to a backup capacitor Cb. By repeating this switching operation, the voltage across the backup capacitor Cb, that is, a voltage Ve-Vd, becomes approximately equal to the voltage Vb-Va. If Vd is a certain fixed voltage, Ve becomes higher than Vd by Vb Va. Conversely, if Ve is a certain fixed voltage, Vd becomes lower than Ve by Vb-Va. The above operation is the basic operation of the charge pump circuit. This circuit functions as a booster circuit or a voltage reduction circuit depending on where the terminals of Va, Vb, Vd, and Ve in FIG. 13 are connected.

1.5 Advantages of Embodiment

Returning to FIG. 1, in a selection period of each scanning electrode, the voltage applied to each pixel is equal to “2·V1” (the potentials applied to the scanning electrode and the signal electrode have different polarities) or “0” (the two potentials have the same polarity). For a pixel that should be turned on, the voltage “2·V1” is a “favorable voltage,” and the voltage “0” is an “unfavorable voltage.” Conversely, for a pixel that should be turned off, the voltage “2·V1” is an “unfavorable voltage,” and the voltage “0” is a “favorable voltage.”

In this embodiment, periods (1f-3f) during which the signal polarity of a selection potential for one line is opposite to that of selection potentials for the other lines, and a period (4f) during which selection potentials having the same polarity are applied to all lines in the group are provided in the all four fields according to an orthonormal matrix. This makes it possible to provide a “favorable voltage” in three of the all four fields irrespective of the value of display data. The reasons will be described below for individual cases.

(1) Display Data of All Bits Are the Same

Where the display data of all bits are the same, a “favorable voltage” can be applied to all pixels in the fourth field (4f). Specifically, where all pixels should be turned on (e.g., the case of the scanning electrodes Y1-Y3 in FIG. 1), it is appropriate to apply potentials that are opposite in polarity to scanning potentials to the signal electrodes. Conversely, where all pixels should be turned off, it is appropriate to apply the same potentials as scanning potentials to the signal electrodes. If the same potentials as in the fourth field (4f) are applied to the signal electrodes in the first to third fields (1f-3f), an “unfavorable voltage” is applied to each pixel once in the first to third fields. A “favorable voltage” is applied in all of the other cases. As a result, a “favorable voltage” can be applied to all pixels in three fields.

(2) Where Display Data of Bits are Different

The phrase “where the display data of the bits are different” refers to cases where the display data of the “particular one bit” out of the three bits is different from the display data of the remaining two bits out of the three bits. In this case, a “favorable voltage” can be applied to all pixels in one of the first to third fields (1f-3f). In the example of the scanning electrodes Y4-Y6 in FIG. 1, the scanning potential waveforms Y4-Y6 have values “1,” “1,” and “0” in the second field (2f), and hence it is appropriate to apply a potential −V1 as the signal potential X1 in this field.

In the fourth field (4f), an “unfavorable voltage” is applied to the pixel of the “particular one bit.” An unfavorable voltage” is applied once to each of the pixels of the “remaining two bits” in the remaining part other than the above field of the first to third fields (in the above example, the first and third fields). In summary, a “favorable voltage” can be applied to all pixels in three fields.

As described above, contrast well suitable for practical use can be secured, and the amplitudes of scanning potentials and signal potentials can be made small by using a liquid-crystal-2-type liquid crystal (see FIG. 3) that is a little high in drive voltage but small in (saturation voltage)/(threshold voltage) ratio. Decreasing the drive voltage makes it possible to remove a booster circuit, simplify the configuration of the power circuit, and reduce the power consumption.

2. Embodiment 2

A liquid crystal display device according to this embodiment has the same or similar configuration as that according to the first embodiment. The liquid crystal display device is provided with the scanning electrodes 54 and the signal electrodes 53 as shown in FIG. 4, which is a schematic of the liquid crystal display device. The STN (super twisted nematic) liquid crystal, in which liquid crystal molecules are arranged with a twist of 180° or more, is interposed between the scanning electrodes 54 and the signal electrodes 53. As in the case of the first embodiment, a description will be provided of an exemplary liquid crystal display device that is a reflection-type liquid crystal display device in which black display is effected when a voltage is applied to the liquid crystal.

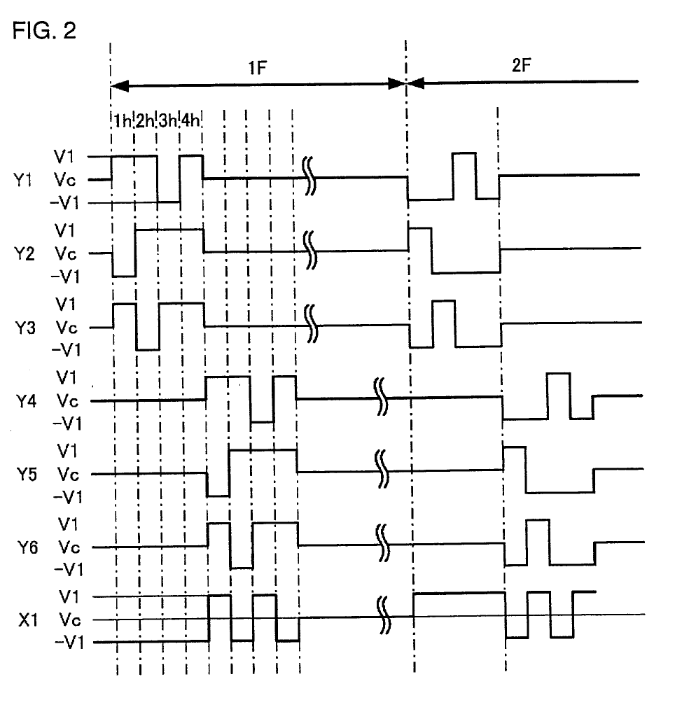

FIG. 2 shows drive waveforms according to this embodiment. The driving method according to this embodiment is provided such that sets of three scanning electrodes (lines) are selected sequentially (three scanning electrodes are selected simultaneously). As in the case of the first embodiment, in certain periods (1h-3h), selection potentials, having signal polarities that are orthogonal to each other and are selected according to an orthonormal matrix, are applied simultaneously to scanning electrodes to be selected simultaneously. In the other period (4h), selection potentials having the same polarity are applied to the respective scanning electrodes.

However, whereas in the first embodiment selection periods (h) are distributed in each field of one frame period (1F), in the second embodiment, the four selection periods 1h-4h that are separated from each other in one frame period in the first embodiment are made a continuous period to constitute selection periods collectively. Reference symbols Y1-Y6 denote scanning potential waveforms that are applied to the respective scanning electrodes 54 (Y1-Y6) shown in FIG. 4, which is the schematic of the liquid crystal display device. Reference symbol X1 denotes a signal potential waveform that is applied to the signal electrode 53 (X1) when a display shown on the signal electrode X1 in FIG. 4 is intended.

Also in this embodiment, scanning potential waveforms (selection potentials) and signal potential waveforms are given the same amplitude. Specifically, with a reference voltage Vc (e.g., 0 V), a positive-side selection potential V1 of scanning potential waveforms and a positive-side potential V1 of signal potential waveforms are given the same voltage level, and a negative-side selection potential −V1 of scanning potential waveforms and a negative-side potential −V1 of signal potential waveforms are given the same voltage level.

According to this embodiment, after scanning potentials are applied to scanning electrodes belonging to a certain group in a certain frame, no scanning potentials are applied to those scanning electrodes until the next frame. Therefore, a memory that stores display data of three lines can be used in place of the frame memory 252 used in the first embodiment (see FIG. 9). This embodiment is advantageous in that the necessary memory capacity can be reduced.

3. Embodiment 3

Next, a third embodiment of the invention will be described. In the first and second embodiments, the number of scanning electrodes, that is, the number of pixels in the Y direction, is equal to 33. However, display that is longer in the vertical direction (Y direction) is now required in cellular phones, etc. To satisfy this requirement, it is conceivable to add, in the Y direction, another matrix that is the same as the one formed by the scanning electrodes 54 and the signal electrodes 53. However, with such a configuration, the wiring lengths become long and the proportion of the display area to the total area of the electro-optical device becomes small. Further, since the number of scanning electrodes increases, wiring patterns need to be made thinner to secure a necessary display area, resulting in an increase in impedance as well as an increase in wiring lengths. These factors may adversely affect the display quality. This embodiment addresses the above problems.

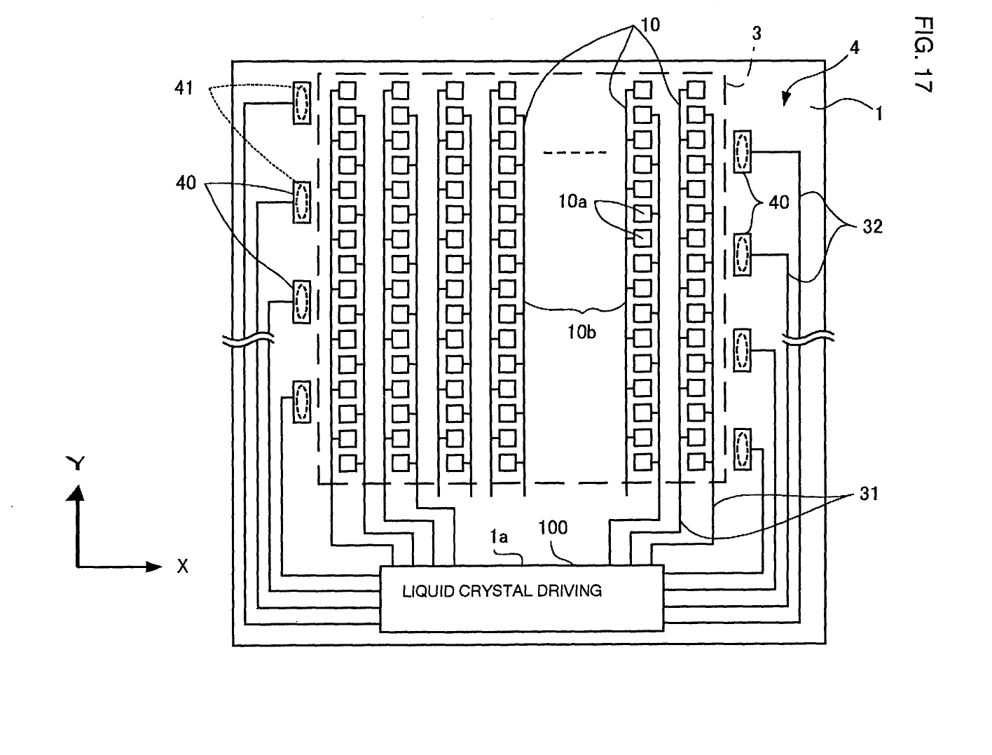

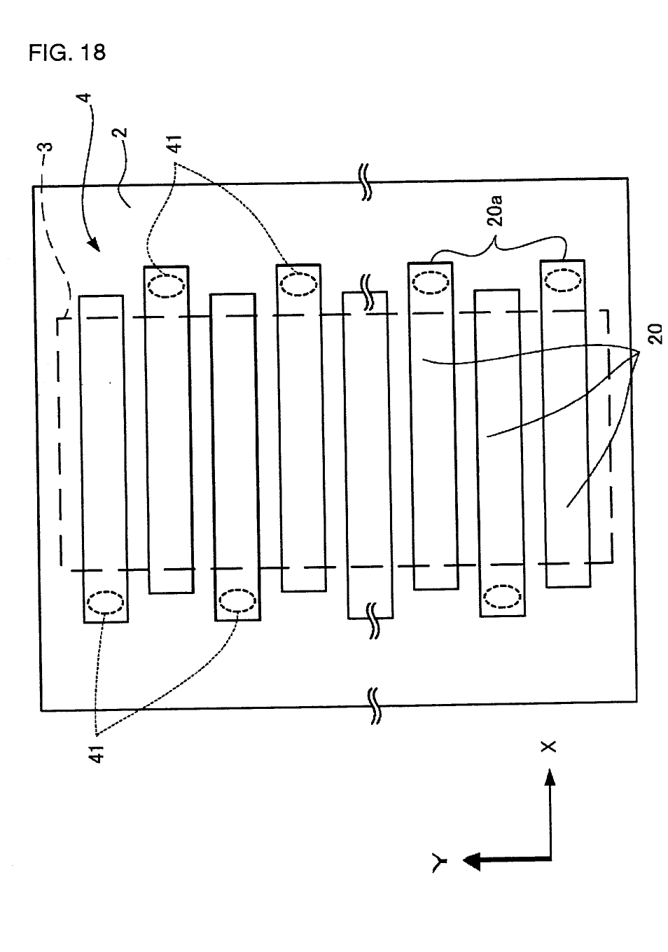

FIGS. 17 and 18 are plan views of a first substrate and a second substrate, respectively, of a liquid crystal display device according to this embodiment. As shown in FIG. 17, a plurality of signal electrodes 10 are arranged on the first substrate 1 in an image display area 3 so as to form a multiple matrix together with scanning electrodes 20. In particular, each signal electrode 10 is formed by a plurality of pixel electrode portions 10a corresponding to respective pixels and a signal wiring portion 10b that is connected to the pixel electrode portions 10a. Each signal electrode 10 extends in the Y direction.

On the other hand, as shown in FIG. 18, a plurality of scanning electrodes 20 are arranged on the second substrate 2 in such a manner that each scanning electrode 20 lies over or under pixel electrode portions 10a of the different signal electrodes 10. Each scanning electrode 20 extends in the X direction. The scanning electrodes 20 and the signal electrodes 10 correspond to the scanning electrodes 54 and the signal electrodes 53 in FIG. 4, respectively. Reference numeral 100 denotes a driving circuit that is formed of a signal line driver and a scanning line driver.

As shown in FIG. 17, a plurality of first wiring lines 31 that connect one end, closer to the driving circuits, of each of the respective signal electrodes 10 to the driving circuit 100 are arranged in a frame area 4. Second wiring lines 32 that connect top-bottom conduction terminals 40 provided on the first substrate 1 to the driving circuit 100 are also arranged in the frame area 4. As shown in FIGS. 17 and 18, top-bottom conduction members 41, that electrically connect the top-bottom conduction terminals 40, provided on the first substrate 1, to end portions 20a, provided on the second substrate 2 and extending from the respective scanning electrodes 20 so as to be located in the frame area 4, are provided in the frame area 4 between the first substrate 1 and the second substrate 2.

As described above, in this embodiment, since the one end, closer to the driving circuit 100, of each of the respective signal electrodes 10 are connected to the driving circuit 100 by the first wiring lines 31 in the frame area 4, the first wiring lines 31 need not run around the image display area 3 (see FIG. 17). Therefore, basically, the wiring lengths of the first wiring lines 31 can be very short.

In the double matrix structure shown in FIG. 17, the width of each of the scanning electrodes 20 to which scanning signals Y1, Y2, . . . are supplied corresponds to two pixels, so that the scanning electrodes 20 are opposed to pixels arranged in the Y direction and formed by two, adjacent to each other, of the signal electrodes 20 to which image signals X1, X2, . . . are supplied. On the other hand, the total number of scanning electrodes 20 is about ½ of that of the case of a non-multiple matrix structure (i.e., so to speak, a single matrix structure in which pixels correspond, one to one, to the crossing points of the scanning electrodes and the signal electrodes).

In general, where the signal electrodes 10 form an n-fold matrix structure (n: an integer greater than or equal to 2), the width of each of the scanning electrodes 20 corresponds to n pixels, so that the scanning electrodes 20 are opposed to pixels arranged in the Y direction and formed by n signal electrodes 20 adjacent to each other, and the total number of scanning electrodes 20 is about 1/n of that of the case of a non-multiple matrix structure. On the other hand, the number of first wiring lines 31 is n times that of the case of a non-multiple matrix structure. However, since originally the first wiring lines 31 are short, an increase in the number of first wiring lines 31 does not increase the frame area 4 very much.

In this embodiment, with attention paid to the width and the total number of scanning electrodes 20 that are determined in connection with the multiple matrix structure, the top-bottom conduction terminals 40, that are in contact with the respective top-bottom conduction members 41 that are connected to the end portions 20a of the respective scanning electrodes 20, are connected to the driving circuit 100 by the second wiring lines 32, as shown in FIG. 17. This decreases the total number of second wiring lines 32 to about 1/n of that of the case of a non-multiple matrix structure. For example, where the image display area 3 accommodates 100 pixels in the X direction and 66 pixels in the Y direction, it is sufficient to provide 33 second wiring lines 32.

Therefore, the total area of the second wiring lines 32 in the frame area 4 can be made to be as small as 1/n of that of the case of a non-multiple matrix structure. That is, in spite of the use of the one-chip driving circuit 100, an increase in the area of the frame area 4 where the second wiring lines 32 run can be suppressed very efficiently. Conversely, the width of each scanning electrode 20 is about n times of that of each pixel as shown in FIG. 18, and hence is much greater than that of each signal electrode 10. Therefore, the use of the onechip driving circuit 100 requires almost no miniaturization.

As a result of the above features, the frame area 4 can be made to be small relative to the image display area 3 by using the first wiring lines 31 having relatively short length, and the second wiring lines 32 that are relatively small in number as shown in FIG. 17. In addition, the total number of top-bottom conduction terminals 40, each of which needs to occupy a certain area in the frame area 4 in consideration of a substrate deviation at the time of bonding of the first substrate 1 and the second substrate 2 and other factors, can be as small as about 1/n (n: multiplicity number). This makes it even easier to reduce the frame area 4.

The use of the first wiring lines 31 having relatively short length, and the second wiring lines 32 that are relatively small in number, makes it possible to suppress an increase of the resistance of the wiring lines from the driving circuit 100 to the scanning electrodes 20 and the signal electrodes 10. This makes it possible to reduce, minimize or prevent degradation of image signals and scanning signals due to an increase of the wiring resistance, which in turn enables image display having sufficiently high quality even with the driving circuit 100 that is relatively low in voltage supply ability or low in breakdown voltage. Further, the power consumption for driving can be reduced.

In this connection, since the selection time in one frame of image signals supplied to the signal electrodes 10 from the driving circuit 100 can be made n times longer (n: multiplicity number), the drive voltage can also be lowered by decreasing the duty ratio, which provides another advantage that the contrast ratio and the brightness in the display area 3 can be increased. In addition, the above-described signal electrodes 10 having the multiple matrix structure, first wiring lines 31, second wiring lines 32, and one-chip driving circuit 100 can be formed by the existing miniaturization technologies, which is very advantageous in terms of implementation.

In this embodiment, in particular, the scanning electrodes 20 extend from both sides of the image display area 3 so as to be arranged in an interdigital manner, as shown in FIG. 18. Therefore, it is sufficient to provide top-bottom conduction members 41 in a half of the total number of scanning electrodes 20 on one side of the image display area 3. On the first substrate 1, it is sufficient to provide second wiring lines 32 in a half of their total number in the frame area 4 on each side of the image display area 3, as shown in FIG. 17. As a result, the second wiring lines 32 can be arranged in the frame area 4 in a well-balanced manner. For example, where the image display area 3 accommodates 100 pixels in the X direction and 66 pixels in the Y direction, the second wiring lines 32 may be arranged in such a manner that 17 lines are provided on one side and 18 lines are provided on the other side. In this manner, the portions of the frame area 4 on both sides in the X direction can be narrowed in a well-balanced manner.

4. Embodiment 4

Electronic equipment of high image quality, low power consumption, low cost, and occupying a small space can be realized by using a liquid crystal display device that employs any of the driving methods according to the first to third embodiments as a display device of electronic equipment, such as cellular phones and small information equipment, for example.

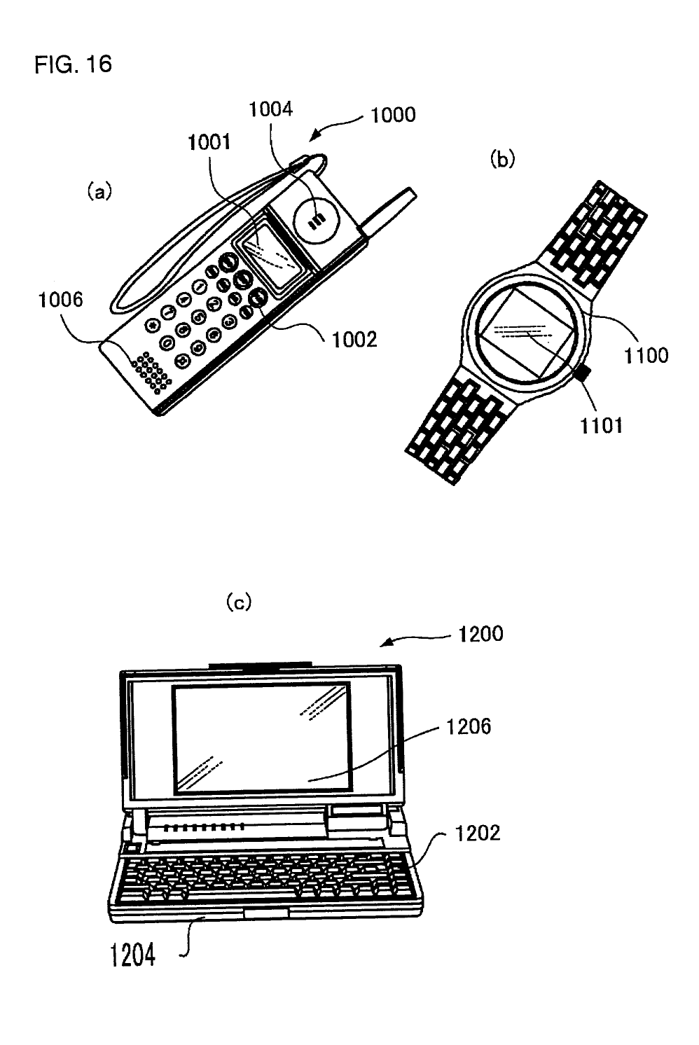

FIGS. 16(a)-16(c) show appearances of exemplary electronic apparatuses using a liquid crystal display device according to the invention. FIG. 16(a) is a perspective view of a cellular phone. Reference numeral 1000 denotes the main body of the cellular phone. Reference numeral 1001 denotes a liquid crystal display section that is part of the main body 1000 and uses a reflection-type liquid crystal display device according to the invention. FIG. 16(b) shows a wrist-watch-type electronic apparatus. Reference numeral 1100 denotes the main body of the watch. Reference numeral 1101 denotes a liquid crystal display section using a reflection-type liquid crystal display device according to the invention. Since this liquid crystal display device has higher-resolution pixels than the display sections of conventional watches, it can be so constructed as to be able to display even TV images (wrist-watch-type TV receiver).

FIG. 16(c) shows a portable information processing apparatus, such as a word processor or a personal computer, for example. Reference numeral 1200 denotes the information processing apparatus; 1202 an input section, such as a keyboard; 1206, a display section using a liquid crystal display device according to the invention; 1204, the main body of the information processing apparatus.

Each of the above electronic apparatus are driven by a battery, and thus can use IC driving circuits with low drive voltages, in which case the battery life can be made to be longer. Further, employment of a one-chip driver IC decreases the number of parts greatly, enabling further reduction in size and weight.

5. Modifications

The invention is not limited to the above embodiments and various modifications are possible as exemplified below.

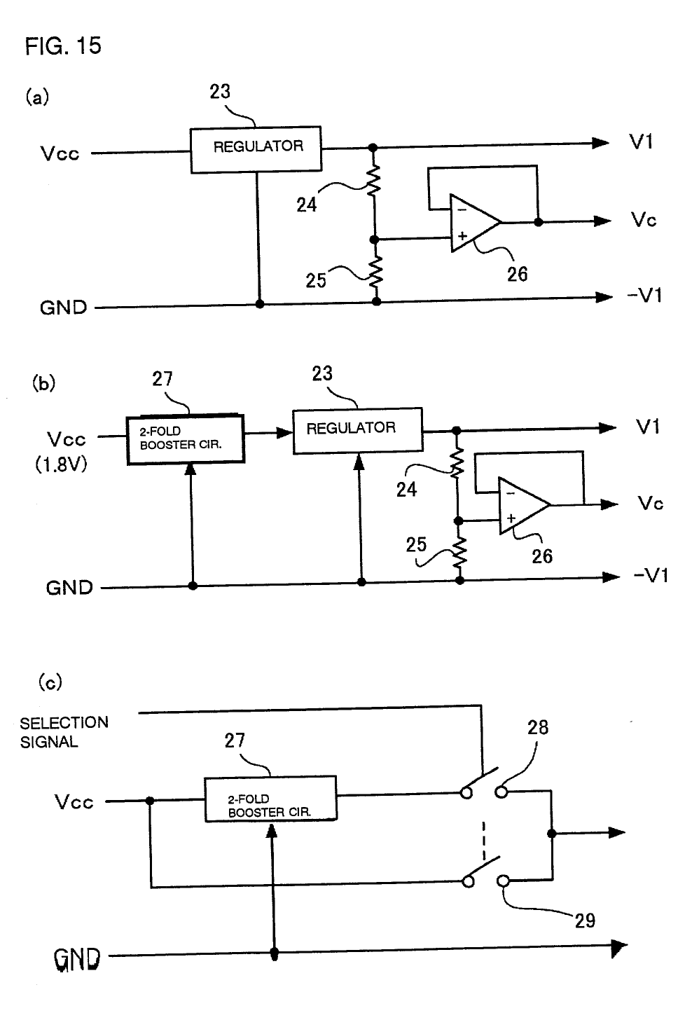

(1) The power circuit of FIG. 14 can be modified as shown in FIG. 15(a). In FIG. 15(a), a voltage that is output from a regulator 23 is divided by resistors 24 and 25 having the same resistance value and a potential Vc is output from the connecting point of the resistors 24 and 25. Reference numeral 26 denotes a voltage follower circuit that is an operational amplifier and serves to output the potential Vc in a stable manner.

(2) Where the power supply voltage of an electronic apparatus to which any of the first to third embodiments is applied is 1.8 V, a power circuit shown in FIG. 15(b) may be used. This power circuit can be configured in such a manner that a 2-fold booster circuit 27 is provided upstream of the power circuit of FIG. 15(a), whereby boosting from 1.8 V to 3.6 V is performed in advance. The part downstream of the 2-fold booster circuit 27 is the same as in the power circuit of FIG. 15(a).

(3) A circuit shown in FIG. 15(c) may be provided upstream of the power circuit of FIG. 14 or FIG. 15(a). In FIG. 15(c), reference numerals 28 and 29 denote switches that are turned on/off complementarily and thereby select a boosted voltage by a 2-fold booster circuit 27 or a voltage Vcc. A selection signal for the switches 28 and 29 may be supplied by a jumper line or the like in accordance with the voltage Vcc. Specifically, the switch 29 is turned on if the voltage Vcc is equal to 3 V, and the switch 28 is turned on if the voltage Vcc is equal to 1.8 V. This configuration makes it possible to use a common power circuit irrespective of the supply voltage that can be supplied from main body apparatus.

(4) The first embodiment employs four separate selection periods. Alternatively, the number of separate selection periods may be decreased to two by combining two “h” periods. As a further alternative, a distribution method described in Japanese Patent Laid-Open No. 15556/1997 may be employed. Although each of the above embodiments is directed to the case that the number of lines selected simultaneously is three, it may be any number such as 2, 4, 5, 6, 7, . . . Although the first and second embodiments are directed to the case that the number of scanning electrodes to be driven is 33, it goes without saying that it may also be determined arbitrarily.

(5) Although each of the above embodiments is directed to the case that binary display (on/off display) is performed in the electro-optical device, an electro-optical device can similarly be realized that performs gray scale display by applying pulse-width-modulated (PWM) or frame-rate-controlled (FRC) voltage waveforms, for example, to the signal electrodes in selection periods.

(6) Although each of the above embodiments is directed to the case of using a reflection-type STN liquid crystal as the liquid crystal of the liquid crystal panel, the liquid crystal is not limited to this structure. Various liquid crystals can be used as exemplified by bistable liquid crystals, such as a ferroelectric liquid crystal and an antiferroelectric liquid crystal, a polymer dispersion type liquid crystal, a TN liquid crystal, and a nematic liquid crystal. Although each of the above embodiments is directed to the case that the liquid crystal panel uses a reflection-type liquid crystal, the invention can also be applied to a transmission-type liquid crystal panel.

(7) Although each of the above embodiments is directed to the case that the liquid crystal panel is a passive matrix liquid crystal panel, the driving method according to the invention can be applied to an active matrix liquid crystal panel in which pixel electrodes are arranged in matrix form on one panel substrate, switching elements that are two-terminal nonlinear elements are connected to the respective pixel electrodes, and series electrical connections of a liquid crystal layer and a two-terminal switching element are provided between scanning electrodes and signal electrodes.

6. Advantages of the Invention

As described above, according to the invention, the drive voltages can be set low and the number of drive voltage levels can be decreased. Therefore, the total power consumption of the power circuit, driving circuit, liquid crystal panel, etc. of the liquid crystal display device can be reduced and the power circuit and the driving circuit can be simplified. This makes it possible to realize electronic equipment of high display quality, low power consumption, low cost, and that occupies a small space.

What is claimed is:

1. A liquid crystal display elements driving method for causing liquid crystal display elements to display gray shades by using a plurality of scanning electrodes, a prescribed number of liquid crystal display elements arranged for each of the plurality of scanning electrodes, and a prescribed number of signal electrodes that cross the plurality of scanning electrodes and correspond to the prescribed number of liquid crystal display elements, comprising:
simultaneously applying scanning signals of one of three predetermined voltages to three scanning electrodes and thereby simultaneously selecting the prescribed number of liquid crystal display elements arranged for each of the three scanning electrodes, the one voltage being determined according to an orthogonal function that prescribes voltages to be applied to the plurality of scanning electrodes; and
applying a data signal of one of the three voltages to each of the prescribed number of signal electrodes, the one voltage being determined according to display data that prescribe gray shades.

2. The liquid crystal display elements driving method according to claim 1, maximum and minimum voltages of the three voltages having the same amplitude and opposite polarities.

3. An electronic apparatus that can perform the liquid crystal display elements driving method according to claim 1.

4. A liquid crystal display device in which a plurality of scanning electrodes and a plurality of signal electrodes are arranged so as to cross each other, the scanning electrodes are divided into groups each consisting of n(n≧2) scanning electrodes that are selected simultaneously, and selection among the scanning electrodes is performed group by group, wherein
selection signals that are orthogonal to each other in a certain period are applied simultaneously to the scanning electrodes belonging to the same group, the number of drive potential levels is three, and a maximum voltage amplitude given to the scanning electrodes is set equal to a maximum voltage amplitude given to the signal electrodes.

5. The liquid crystal display device according to claim 4, wherein the first or second potential is applied to the signal electrodes so that a voltage applied to a crossing portion of each of the scanning electrodes and each of the signal electrodes becomes a favorable voltage to display data for the crossing portion p times (p>(n+1)/2) and becomes an unfavorable voltage to the display data (n+1−p) times.

6. The liquid crystal display device according to claim 5, wherein the number p of times the favorable voltage is applied is equal to the number n of scanning electrodes of each group.

7. The liquid crystal display device according to claim 4, wherein the first potential and the second potential have opposite polarities and the same absolute value with respect to an average value of potentials applied to the respective scanning electrodes.

8. The liquid crystal display device according to claim 4, wherein each of the potentials is so set that a ratio of an on-voltage to an off-voltage of an effective voltage applied to a liquid crystal becomes greater than or equal to a ratio of a saturation voltage to a threshold voltage of the liquid crystal.

9. The liquid crystal display device according to claim 4, wherein the number of the scanning electrodes belonging to each group is three.

10. The liquid crystal display device according to claim 4, wherein the scanning electrode and the signal electrodes are cross-arranged so as to assume a multiple matrix.

11. A liquid crystal display device in which a plurality of scanning electrodes and a plurality of signal electrodes are arranged so as to cross each other, the scanning electrodes are divided into groups each consisting of n(n≧2) scanning electrodes that are selected simultaneously, and selection among the scanning electrodes is performed group by group, wherein
that a first potential or a second potential that is opposite in polarity to and has the same absolute value as the first potential with respect to an average of potentials applied to the respective scanning electrodes is selectively applied to the signal electrodes; and
that the first or second potential is selectively applied to a scanning electrode corresponding to a display position in a period when the first or second potential is applied to the signal electrodes.

12. The liquid crystal display device according to claim 4, wherein selection signals to be applied to the scanning electrodes of the same group are applied at a plurality of time points in one frame period.

13. The liquid crystal display device according to claim 4, wherein selection signals to be applied to the scanning electrodes of the same group are applied at once in one frame period.

14. A driving method of a liquid crystal display device in which a plurality of scanning electrodes and a plurality of signal electrodes are arranged so as to cross each other, the scanning electrodes are divided into groups each consisting of n(n≧2) scanning electrodes that are selected simultaneously, and selection among the scanning electrodes is performed group by group, wherein
selection signals that are orthogonal to each other in a certain period are applied simultaneously to the scanning electrodes belonging to the same group, the number of drive potential levels is three, and a maximum voltage amplitude given to the scanning electrodes is set equal to a maximum voltage amplitude given to the signal electrodes.

15. The driving method of the liquid crystal display device according to claim 14, wherein the first or second potential is applied to the signal electrodes so that a voltage applied to a crossing portion of each of the scanning electrodes and each of the signal electrodes becomes a favorable voltage to display data for the crossing portion p times (p>(n+1)/2) and becomes an unfavorable voltage to the display data (n+1−p) times.

16. The driving method of the liquid crystal display device according to claim 15, wherein the number p of times the favorable voltage is applied is equal to the number n of scanning electrodes of each group.

17. The driving method of the liquid crystal display device according to claim 14, wherein the first potential and the second potential have opposite polarities and the same absolute value with respect to an average value of potentials applied to the respective scanning electrodes.

18. The driving method of the liquid crystal display device according to claim 14, wherein each of the potentials is so set that a ratio of an on-voltage to an off-voltage of an effective voltage applied to a liquid crystal becomes greater than or equal to a ratio of a saturation voltage to a threshold voltage of the liquid crystal.

19. The driving method of the liquid crystal display device according to claim 14, wherein the number of scanning electrodes belonging to each group is three.

20. The driving method of the liquid crystal display device according to claim 14, wherein the scanning electrode and the signal electrodes are cross-arranged so as to assume a multiple matrix.

21. A driving method of a liquid crystal display device in which a plurality of scanning electrodes and a plurality of signal electrodes are arranged so as to cross each other, the scanning electrodes are divided into groups each consisting of n(n≧2) scanning electrodes that are selected simultaneously, and selection among the scanning electrodes is performed group by group, wherein
a first potential or a second potential that is opposite in polarity to and has the same absolute value as the first potential with respect to an average of potentials applied to the respective scanning electrodes is selectively applied to the signal electrodes; and
the first or second potential is selectively applied to a scanning electrode corresponding to a display position in a period when the first or second potential is applied to the signal electrodes.

22. The driving method of the liquid crystal display device according to claim 14, wherein selection signals to be applied to the scanning electrodes of the same group are applied at a plurality of time points in one frame period.

23. The driving method of the liquid crystal display device according to claim 14, wherein selection signals to be applied to the scanning electrodes of the same group are applied at once in one frame period.

24. A driving circuit of a liquid crystal display device which drives a liquid crystal display device in which a plurality of scanning electrodes and a plurality of signal electrodes are arranged so as to cross each other, the scanning electrodes are divided into groups each consisting of n(n≧2) scanning electrodes that are selected simultaneously, and selection among the scanning electrodes is performed group by group, wherein
selection signals that are orthogonal to each other in a certain period are applied simultaneously to the scanning electrodes belonging to the same group, the number of drive potential levels is three, and a maximum voltage amplitude given to the scanning electrodes is set equal to a maximum voltage amplitude given to the signal electrodes.

25. The driving circuit of the liquid crystal display device according to claim 24, wherein the first or second potential is applied to the signal electrodes so that a voltage applied to a crossing portion of each of the scanning electrodes and each of the signal electrodes becomes a favorable voltage to display data for the crossing portion p times (p>(n+1)/2) and becomes an unfavorable voltage to the display data (n+1−p) times.

26. The driving circuit of the liquid crystal display device according to claim 25, wherein the number p of times the favorable voltage is applied is equal to the number n of scanning electrodes of each group.

27. The driving circuit of the liquid crystal display device according to claim 24, wherein the first potential and the second potential have opposite polarities and the same absolute value with respect to an average value of potentials applied to the respective scanning electrodes.

28. The driving circuit of the liquid crystal display device according to claim 24, wherein each of the potentials is so set that a ratio of an on-voltage to an off-voltage of an effective voltage applied to a liquid crystal becomes greater than or equal to a ratio of a saturation voltage to a threshold voltage of the liquid crystal.

29. The driving circuit of the liquid crystal display device according to claim 24, wherein the number of scanning electrodes belonging to each group is three.

30. The driving circuit of the liquid crystal display device according to claim 24, wherein the scanning electrode and the signal electrodes are cross-arranged so as to assume a multiple matrix.

31. A driving circuit of a liquid crystal display device which drives a liquid crystal display device in which a plurality of scanning electrodes and a plurality of signal electrodes are arranged so as to cross each other, the scanning electrodes are divided into groups each consisting of n(n≧2) scanning electrodes that are selected simultaneously, and selection among the scanning electrodes is performed group by group, wherein
that a first potential or a second potential that is opposite in polarity to and has the same absolute value as the first potential with respect to an average of potentials applied to the respective scanning electrodes is selectively applied to the signal electrodes; and
that the first or second potential is selectively applied to a scanning electrode corresponding to a display position in a period when the first or second potential is applied to the signal electrodes.

32. The driving circuit of the liquid crystal display device according to claim 24, wherein selection signals to be applied to the scanning electrodes of the same group are applied at a plurality of time points in one frame period.

33. The driving circuit of the liquid crystal display device according to claim 24, wherein selection signals to be applied to the scanning electrodes of the same group are applied at once in one frame period.
